(19) United States
(12) Patent Application Publication
(10) Pub. No.: US 2007/0092437 A1
(43) Pub. Date: Apr. 26, 2007

(54) Increasing hydrogen adsorption of nanostructured storage materials by modifying sp2 covalent bonds

(76) Inventors: Young-Kyun Kwon, Albany, CA (US); Seung-Hoon Jhi, Albany, CA (US); Keith Bradley, El Cerrito, CA (US); Philip G. Collins, Oakland, CA (US); Jean-Christophe P. Gabriel, Pinole, CA (US); George Gruner, Los Angeles, CA (US)

Correspondence Address: O'MELVENY & MYERS LLP, 610 NEWPORT CENTER DRIVE, 17TH FLOOR, NEWPORT BEACH, CA, 92660, US

(21) Appl. No.: 10/020,344

(22) Filed: Dec. 11, 2001

(51) Int. Cl. C01B 3/00

(52) U.S. Cl. 423/658.2; 977/742

(57) ABSTRACT

According to the invention, nanostructured storage materials are provided for storing hydrogen. The nanostructured storage materials can include a network of light elements, such as Be, B, C, N, O, F, Mg, P, S, and Cl, coupled with sp² bonds. The hydrogen adsorption to the nanostructured storage material is improved by modifying the sp² bonds. The sp² bonds can be modified by forming the nanostructured storage material from the above light elements, possibly with a shape other than a planar layer, and by introducing defects. A chemical vapor deposition technique can be used for the synthesis, where doping gases are included into the flow. Methods for forming the nanostructured storage material with defects include removing light elements from the nanostructured storage material by irradiation with electrons, neutrons, ions, gamma rays, X-rays, and microwaves.

### REFERENCE TO CROSS RELATED APPLICATIONS

The present application is related to co-pending U.S. patent application entitled: “Hydrogen Storage in Nanostructures with Physisorption,” by Keith Bradley, Philip G. Collins, Jean-Christophe P. Gabriel, Young-Kyun Kwon, Seung-Hoon Jhi, and George Grüner, attorney docket number M-12323, filed simultaneously with the present application, hereby incorporated in its entirety by reference.

### BACKGROUND

1. Field of the Invention

The invention relates to hydrogen storage systems, more particularly to improving the adsorption of hydrogen in storage systems containing nanostructures.

2. Description of Related Art

Hydrogen storage is the key unsolved problem of producing fuel cells for hydrogen-powered automobiles or portable energy devices. In particular, storing hydrogen in large quantities safely and in a light container proved prohibitively difficult so far.

Several different techniques have been developed to tackle this problem. In some approaches hydrogen is stored in tanks under high pressure, for example, 300 atm. In other techniques hydrogen is liquefied at temperatures below 20 K with a helium-based cooling system. Both of these techniques pose problems for practical use in automobiles. For example, all of the hydrogen is available for catastrophic release in an accident, raising the risk of explosion or fire. Furthermore, in order to store enough hydrogen to match the range of present day automobiles, the container has to have a volume of at least 50 gallons. Also, both in the high-pressure technique and in the helium-cooled technique the required containers are heavy, and therefore inefficient for storage. Finally, both techniques consume a lot of energy for generating the high pressure or for liquefying the hydrogen.

Some other techniques adsorb hydrogen into solid materials. Several types of materials have been studied in this respect, including metal hydrides and glass microspheres. However, all the materials investigated so far have low hydrogen storage capacity, making them non-competitive with gasoline.

Hydrogen can also be stored in carbon nanostructures, such as graphite or carbon nanofibers, according to the papers of A. Dillon et al. in Nature, vol. 386, p. 377 (1997), A. Chambers et al. in J. Phys. Chem. B vol. 102, p. 3378 (1998), and E. Poirier et al. in Int. J. of Hydrogen Energy, vol. 26, p. 831 (2001), and according to U.S. Pat. No. 5,663,951: “Storage of hydrogen in layered nanostructures,” by N. Rodrgiuez and R. Baker, and U.S. Pat. No. 4,960,450: “Selection and preparation of activated carbon for fuel gas storage,” by J. Schwarz et al.

Nanostructures can be defined as atomic structures that have a spatial extent of less than a few hundred nanometers in one, two, or all three dimensions. A class of nanostructures is formed by planar networks, sometimes referred to as layered compounds. Layered compounds are often formed by elements coupled with sp² bonds. The origin of the sp² bonds will be presented on the example of elements of the second row of the periodic table, including boron, carbon, and nitrogen.

FIG. 1 shows an example of a second row element 4 coupled with sp² bonds, or orbitals, 8 to three other elements 12. The s orbital of the second row elements is filled with two electrons, and the p orbitals are partially filled. For example, boron has one electron, carbon has two, and nitrogen has three electrons in the p orbitals. When the second row elements form chemical bonds, one of the s electrons is promoted into an empty p orbital—for example into the p_{z} orbital in carbon, leaving only one s electron. This one s electron and two of the p electrons hybridize into three sp² hybrid orbitals. The remaining p electrons—none in boron, one in carbon, and two in nitrogen—occupy a p orbit that does not participate in the bonding. The three hybridized electrons repel each other, and hence form three sp² orbitals 8 as far as possible away from each other. An optimal configuration is when the three sp² orbitals 8 make 120 degrees with each other, defining a plane. Connecting several second row elements with planar sp² orbitals 8 spans the defined plane, thus forming the aforementioned planar networks. Possible planar networks of the sp² bonded materials include triangular lattices.

Typically hydrogen adsorbs to nanostructures with physical interactions, an example of which is the van der Waals interaction. Such an adsorption is referred to as physisorption, in contrast to chemisorption, where the adsorbate forms a chemical bond with the surface. A detailed comparison between physisorption and chemisorption is provided in co-pending U.S. patent application, entitled: “Hydrogen Storage in Nanostructures with Physisorption,” by Keith Bradley, Philip G. Collins, Jean-Christophe P. Gabriel, Young-Kyun Kwon, Seung-Hoon Jhi, and George Giner.

FIG. 2A illustrates the bonding of a hydrogen molecule 16 to a triangular sp² bonded layer 20 of carbon atoms, wherein the triangular layer is sometimes referred to as a graphene sheet.

FIG. 2B illustrates the energy of hydrogen molecule 16, expressed in electron Volts, as a function of distance from triangular sp² bonded layer 20, expressed in Nanometers. Hydrogen molecule 16 will typically be located at a distance from the graphene sheet where the energy is lowest. In the example of FIG. 2B this distance is about 0.27 nanometers. The minimum value of the energy is often referred to as a binding energy, E_{B}, which in this example takes the value of E_{B}(planar)=0.10 eV.

Storing hydrogen in sp² bonded nanostructures has the following advantages. Hydrogen, adsorbed to the nanostructures, desorbs slowly and thus it is not available for catastrophic release, for example, in an automobile accident. Furthermore, because of their large surface area, nanostructures are capable of bonding very large quantities of hydrogen, giving rise to a much higher weight % storage efficiency than the aforementioned high pressure and cooling techniques.

However, the referenced works have the following disadvantages. Typically they consider hydrogen storage at ambient temperatures, where the storage capacity falls far short of the theoretical value, making those works economically non-viable. Also, the works that consider storage at other temperatures reported insufficient storage efficiencies.

FIG. 3 shows the amount of hydrogen, adsorbed on triangular sp² bonded layer 20, as a function of temperature, expressed as a percentage of the amount of hydrogen adsorbed at zero temperature. As shown in FIG. 3, hydrogen desorbs from triangular sp² bonded layer 20 at a relatively well defined the desorption temperature, T_{D}. At about 120-140% of T_{D} practically all hydrogen is desorbed.

The desorption temperature, T_{D}, depends on the pressure, as illustrated in FIG. 3. For example, raising the pressure from about 1 atm to about 10 atm, and then from about 10 atm to about 100 atm increases the desorption temperature about 20% each time. In FIG. 3 the temperature T is shown relative to the desoprtion temperature T_{D} at 1 atm pressure, T_{D}(1 atm). T_{D}(1 atm) is about 60 K for graphene sheets.

The desorption temperature of hydrogen in relation to many nanostructures is well below the ambient temperature of about 300 K. Since large amounts of hydrogen can be stored only at temperatures around or below T_{D}, many adsorption based hydrogen storage systems have to be cooled to provide a competitive storage system.

The desorption temperature T_{D}, determines the type of cooling necessary for the efficient operation of the storage system. Many cooling systems utilize liquid nitrogen or liquid helium as a coolant.

Cooling systems utilizing liquid nitrogen have several advantages over systems utilizing liquid helium. Liquid nitrogen is much cheaper per liter than liquid helium. Nitrogen becomes a liquid at 77 K, whereas helium becomes a liquid at 4.2 K. It requires much less energy to cool a system to a temperature of 77 K, than to a temperature of 4.2 K. It also requires a much simpler and therefore lighter cooling apparatus to maintain a temperature of about 77 K, than to maintain a temperature of about 4.2 K.

Therefore there is a need for hydrogen storage systems that contain sp² bonded nanostructures, wherein the composition and structure of the nanostructure is selected to ensure high storage efficiency, and wherein the hydrogen adsorbs to the nanostructure with a binding energy large enough to permit operating the hydrogen storage system at technologically advantageous temperatures.

### SUMMARY

According to the invention, a nanostructured storage material is provided, capable of storing hydrogen. The nano structured storage material includes a network of light elements, wherein the light elements are selected from Be, B, C, N, O, F, Mg, P, S, and Cl. Light elements are utilized to improve the weight % storage efficiency of storage systems, and thus making them more competitive.

Theoretical considerations and experiments have shown that some networks, containing modified sp² bonds, are capable of adsorbing more hydrogen than planar triangular lattices that are formed from one type of atoms, which are coupled by sp² bonds. In embodiments of the invention the hydrogen adsorption to nanostructured storage material is improved by suitably modifying the sp² bonds of a network to increase the binding energy of hydrogen.

The sp² bonds of the nanostructured storage material can be modified by several methods. These methods include forming the nanostructured storage material from the above selected light elements; forming the nanostructured storage material with a shape other than a planar layer; and introducing defects into the nanostructured storage material.

Hydrogen has a higher binding energy to the nanostructured storage materials with modified sp² bonds that correspond to embodiments of the invention. A higher binding energy causes a higher desorption temperature for hydrogen, making the nanostructured storage materials, corresponding to embodiments of the invention, economically competitive for storing hydrogen in transportation and other applications.

Methods for forming the nanostructured storage material with a chemical composition that modifies the sp² bonds include using a chemical vapor deposition technique, where doping gases are included into the flow of the chemical vapor deposition synthesis. Other methods include hot-pressing light elements with graphite powder to form electrodes, and then using the electrode for performing an arc synthesis of the nanostructured storage material.

Methods for forming the nanostructured storage material with defects include removing light elements from the nanostructured storage material by irradiation with electrons, neutrons, ions, gamma rays, X-rays, and microwaves. The same irradiation techniques can be used to generate 5-7 defects as well.

### BRIEF DESCRIPTION OF THE DRAWINGS

FIG. 1 illustrates an element forming sp² bonds.

FIG. 2A illustrates a hydrogen molecule adsorbed to a triangular lattice.

FIG. 2B illustrates the dependence of the energy of the hydrogen molecule on the distance between the hydrogen molecule and the triangular lattice.

FIG. 3 illustrates the temperature dependence of the storage capacity of nanostructures as a function of temperature at different pressures.

FIG. 4A illustrates a hydrogen molecule adsorbed to a triangular lattice of binary composition.

FIG. 4B illustrates the dependence of the energy of the hydrogen molecule on the distance between the hydrogen molecule and the triangular lattice of binary composition.

FIG. 4C illustrates a hydrogen molecule adsorbed to a modified triangular lattice of binary composition.

FIG. 4D illustrates the dependence of the energy of the hydrogen molecule on the distance between the hydrogen molecule and the modified triangular lattice of binary composition.

FIG. 5A illustrates a hydrogen molecule adsorbed to a nanocage.

FIG. 5B illustrates the dependence of the energy of the hydrogen molecule on the distance between the hydrogen molecule and the nanocage.

FIG. 6 illustrates a hydrogen molecule adsorbed to a BN nanocage.

FIG. 7A illustrates a hydrogen molecule adsorbed to a nanotube.

FIG. 7B illustrates the dependence of the energy of the hydrogen molecule on the distance between the hydrogen molecule and the nanotube.

FIG. 8A illustrates a hydrogen molecule adsorbed to a carbon layer with an impurity.

FIG. 8B illustrates the dependence of the energy of the hydrogen molecule on the distance between the hydrogen molecule and the carbon layer with an impurity.

FIG. 8C illustrates the dependence of the energy of the hydrogen molecule on the distance between the hydrogen molecule and the BN layer with an impurity.

FIG. 9A illustrates a hydrogen molecule adsorbed to a layer with a 6 atom vacancy.

FIG. 9B illustrates the dependence of the energy of the hydrogen molecule on the distance between the hydrogen molecule and the carbon layer with a hexagonal defect.

FIG. 10A illustrates a hydrogen molecule adsorbed to a layer with a 5-7 defect.

FIG. 10B illustrates the dependence of the energy of the hydrogen molecule on the distance between the hydrogen molecule and the layer with a 5-7 defect.

FIG. 11A illustrates a hydrogen molecule adsorbed to a charged layer.

FIG. 11B illustrates the dependence of the energy of the hydrogen molecule on the distance between the hydrogen molecule and the charged layer.

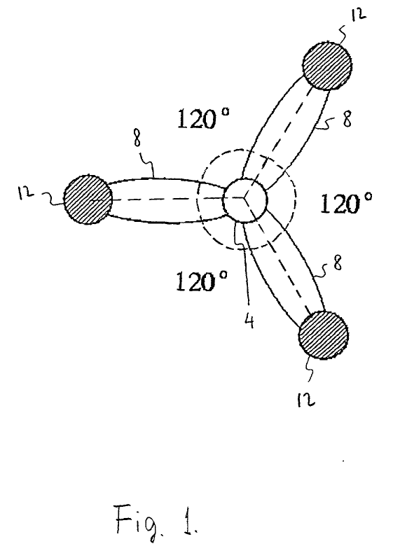

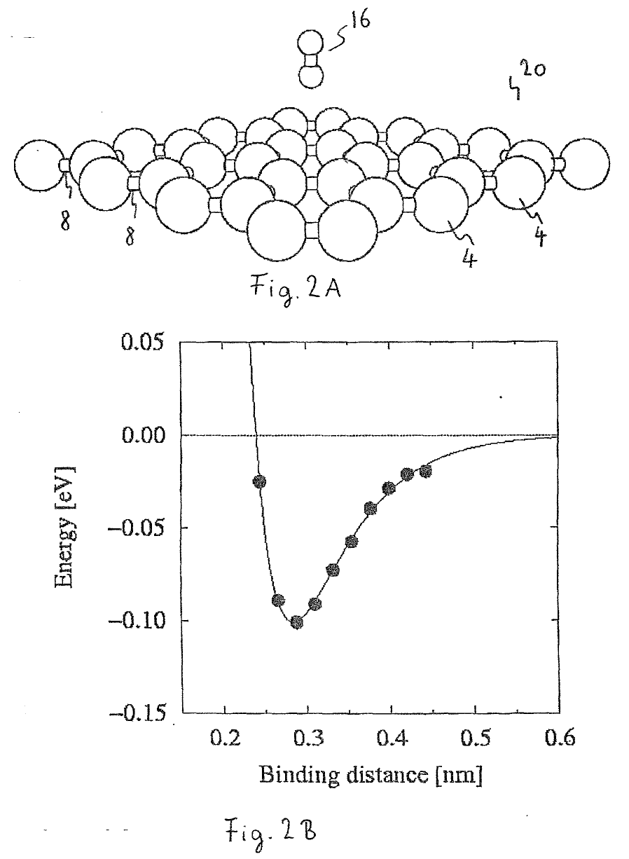

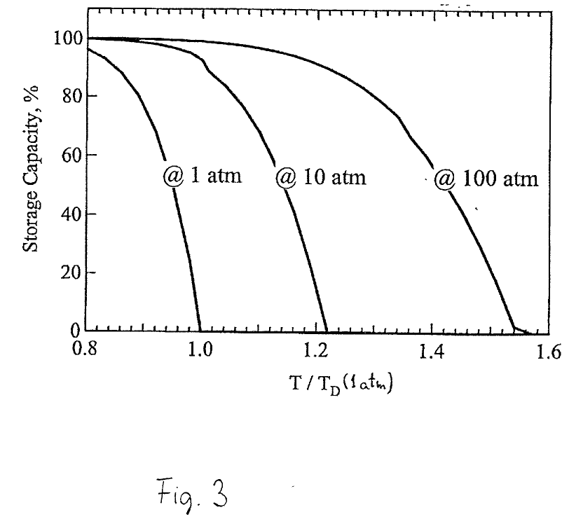

### DETAILED DESCRIPTION

In accordance with the invention, a nanostructured storage material 22 is presented for storing hydrogen. Nanostructured storage material 22 includes a network of light elements 24, selected from Be, B, C, N, O, F, Mg, P, S, and Cl. Light elements 24 are utilized to improve the weight % storage efficiency of nanostructured storage material 22, thus making it suitable for use in transportation and other industrial applications.

Previous works have described planar triangular lattices, formed from one type of atoms, coupled by sp² bonds. In the present invention, the light elements of the network are coupled by modified sp² bonds. Theoretical considerations and experiments have shown that some networks, containing modified sp² bonds, are capable of adsorbing more hydrogen than planar triangular lattices that are formed from one type of atoms, which are coupled by sp² bonds. Modifying the sp² bonds can change the hybridization of the s and p electrons. Changing the hybridization of the s and p electrons modifies the electronic states. The binding of hydrogen molecules is sensitive to the character of the electronic states. Therefore, the binding energy of hydrogen can be controlled by modifying the sp² bonds. In particular, in embodiments of the invention the binding energy of hydrogen is increased by suitably modifying the sp² bonds. In these embodiments the hydrogen adsorption to nanostructured storage material 22 is also improved by modifying the sp² bonds of the network. The improvement of hydrogen adsorption causes, for example, the increase of the desorption temperature T_{D}, and the increase of the hydrogen storage capacity near T_{D}.

The sp² bonds of nanostructured storage material 22 can be modified by several methods. These methods include forming nanostructured storage material 22 from the above selected light elements 24; forming nanostructured storage material 22 with a shape other than a planar layer; and introducing defects into nanostructured storage material 22.

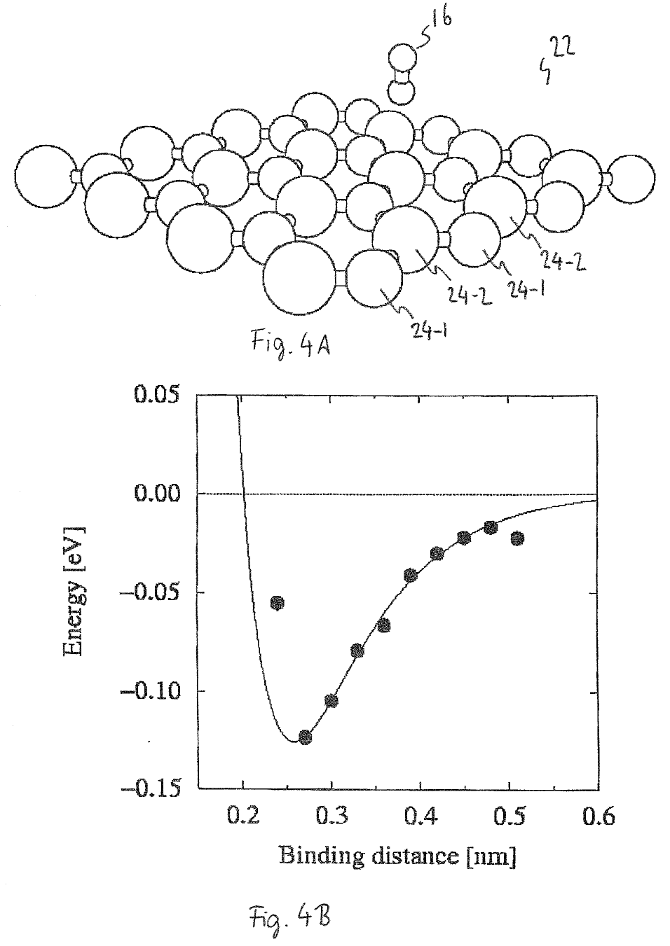

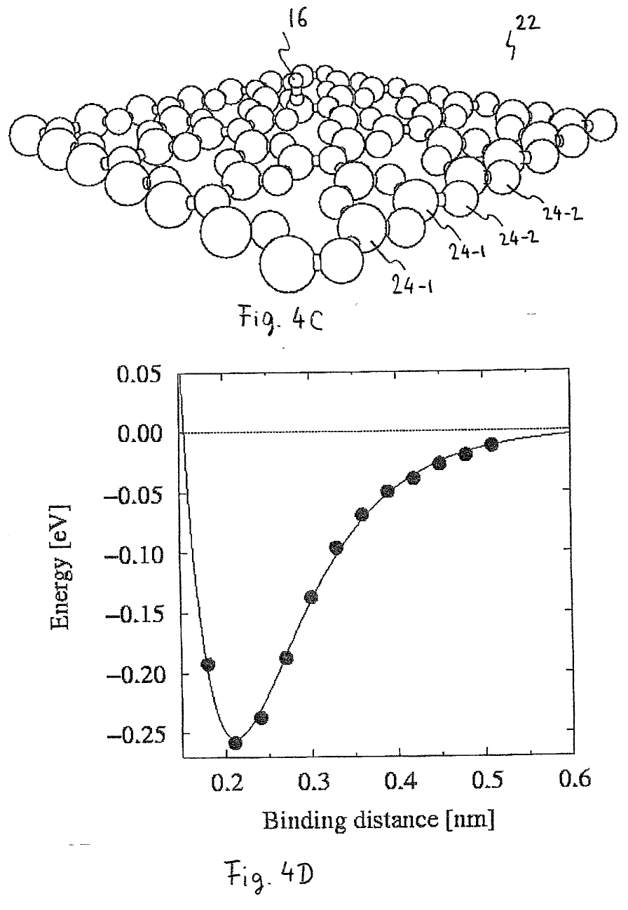

FIG. 4A illustrates an embodiment where the adsorption of hydrogen molecule 16 to nanostructured storage material 22 is enhanced relative to the adsorption to a carbon layer by modifying the sp² bonds via forming nanostructured storage material 22 with a binary composition of two light elements 24-1 and 24-2. For example, the binary composition can be boron nitride, BN. In FIG. 4A boron atoms 24-1 are indicated by large circles and nitrogen atoms 24-2 by small circles.

FIG. 4B illustrates the energy of hydrogen molecule 16 as a function of distance from the plane of nanostructured storage material 22. The binding energy is approximately E_{B}(BN,planar)_{boro}=0.13 eV, when hydrogen molecule 16 adsorbs to boron atoms 24-1, a value about 30% higher than E_{B}(C,planar)=0.10 eV for pure carbon layers.

The binding energy E_{B} determines the desorption temperature T_{D}. For example, the graphene sheet binding energy E_{B}(C,planar)=0.10 eV approximately corresponds to a T_{D}(C,planar) of 60 K at a pressure of 1 atm. As the binding energy of the planar BN layers, E_{B}(BN,planar), is about 30% higher than the binding energy of carbon layers, E_{B}(C,planar), the desorption temperature T_{D}(BN,planar) of BN layers is also enhanced from about 60 K to about 80 K in this embodiment.

FIG. 4C illustrates another embodiment where the adsorption of hydrogen molecule 16 to nanostructured storage material 22 is enhanced relative to the adsorption to a carbon layer by modifying the sp² bonds via forming nanostructured storage material 22 with a binary composition of two light elements 24-1 and 24-2 with the formula A₃B₄. For example, the binary composition can be carbon nitride, C₃N₄. In FIG. 4C carbon atoms 24-1 are indicated by large circles and nitrogen atoms 24-2 by small circles.

FIG. 4D illustrates the energy of hydrogen molecule 16 as a function of distance from the plane of nanostructured storage material 22. The binding energy is approximately E_{B}(CN,planar)=0.26 eV, a value about 160% higher than E_{B}(C,planar)=0.10 eV for pure carbon layers.

Related embodiments include other nanostructured storage materials 22 with planar forms, for example, thin nanoplatelets, thick nanoplatelets, and intercalated nanoplatelets, with thicknesses from about 0.3 nm to about 100 nm, and lateral size from about 0.5 nm to about 500 nm.

All these nanostructured storage materials 22 can acquire higher bonding energies by having a binary chemical composition of the above light elements, instead of a monoatomic composition. In some embodiments binary compositions include BN, MgB₂, Be₃N₂, BeB₂, B₂O, BeO, AlCl₃, Al₄C₃, AlF₃, Al₂O₃, Al₂S₃, Mg₂Si, Mg₃N₂, Li₃N, Li₂S, Na₂S, AlB₂, and Na₂S₄. In some embodiments nanostructured storage material 22 includes mixtures of binary compounds with these chemical compositions.

Also, chemical compositions having more than two elements can enhance the binding energy. Examples include nanostructured storage materials 22 with BₓC_{y}N_{z} type composition, where x, y, and z are integers.

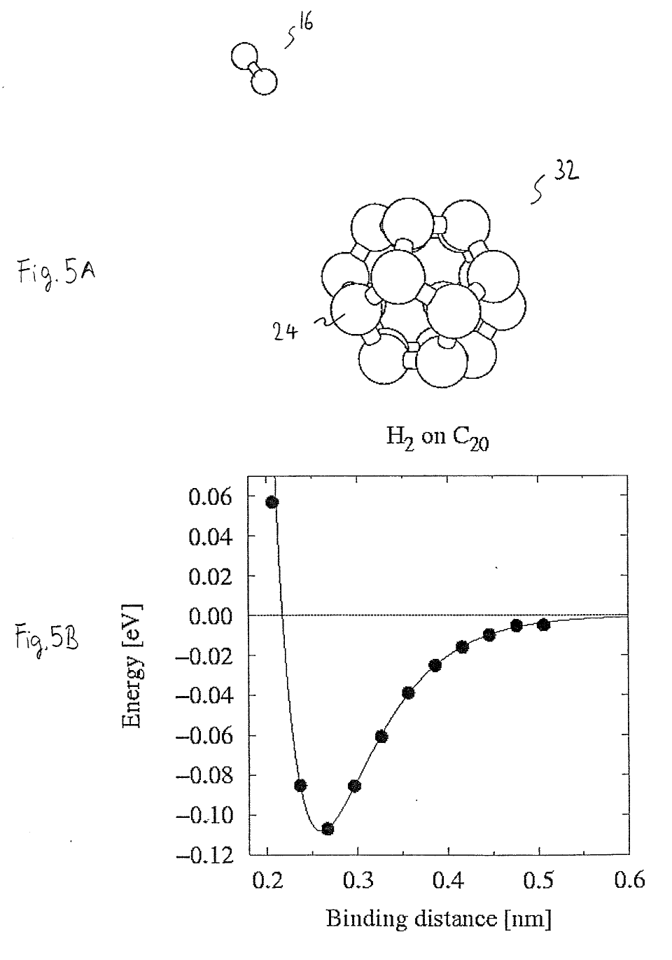

FIG. 5A illustrates some embodiments of the invention, where the adsorption of hydrogen molecule 16 to nanostructured storage material 22 is enhanced by deforming sp² bonds 8. One way to deform sp² bonds 8 is to introduce a curvature into nanostructured storage material 22. FIG. 5A illustrates a nanocage 32, which consists of twenty light elements 24, for example, carbon. Nanocage 32 consists of only 12 pentagons without hexagon ring. Due to the large curvature of the layer of nanostructured storage material 22, the sp² bonding characteristics are significantly modified. Large families of nanocages are known in the art, including nanocages of about 20 to about 100 atoms, as well as empty nanocages, filled nanocages, and multifaceted nanocages. There are also families of nanocages with non-spherical structures. For example, nanocages elongated along an axis are referred to as nanococoons, examples of which include empty nanococoons, filled nanococoons, and multifaceted nanococoons. Nanocages with more extensively deformed shapes include, for example, nanotorii, nanocoils, and nanohoms. Also, the chemical composition of nanocages can be heteroatomic, i.e., they can contain more than one type of atoms. Finally, nanocages can have heterogeneous forms, where a part of the nanocage has one of the above-defined forms and another part of the nanocage has another of the above-defined forms. All varieties of nanocages are understood to be within the scope of the invention.

FIG. 5B illustrates the dependence of energy on the distance between the surface of nanocage 32 and hydrogen molecule 16. The binding energy E_{B}(C,cage) is about 0.11 eV, about 10% bigger than E_{B}(C,planar), corresponding to an enhanced value of T_{D} of about 65 K in this embodiment.

Forming nanocage 32 with a heteroatomic composition, for example, the binary composition of BN, can further enhance the binding energy E_{B} and desorption temperature T_{D}. Some embodiments are formed from other combinations of light elements 24.

FIG. 6 illustrates some embodiment that is a combination of the embodiments of FIG. 4A and 5A. FIG. 6 shows a nanocage 32, with 60 atoms in it. Some embodiments are formed from a single light element 24, others are formed from two different light elements 24-1 and 24-2, such as boron and nitrogen atoms. The chemical notation for this nanocage is B₃₀N₃₀. Nanocages containing 60, or close to 60 atoms, are often referred to as “buckyballs.” Unlike the usual hexagonal boron-nitride layer, where only boron-nitrogen (BN) pair bonds exist, nanocage 32 contains boron-boron (BB) and nitrogen-nitrogen (NN) pair bonds as well as BN pair bonds, because of 12 pentagons in its structure. Therefore, nanocage 32 exhibits unique electronic properties compared to sp²-bonded boron-nitride systems, which do not have BB or NN pair bonds. The binding energy E_{B}(buckyball) and T_{D}(buckyball) is also enhanced relative to E_{B}(C,planar).

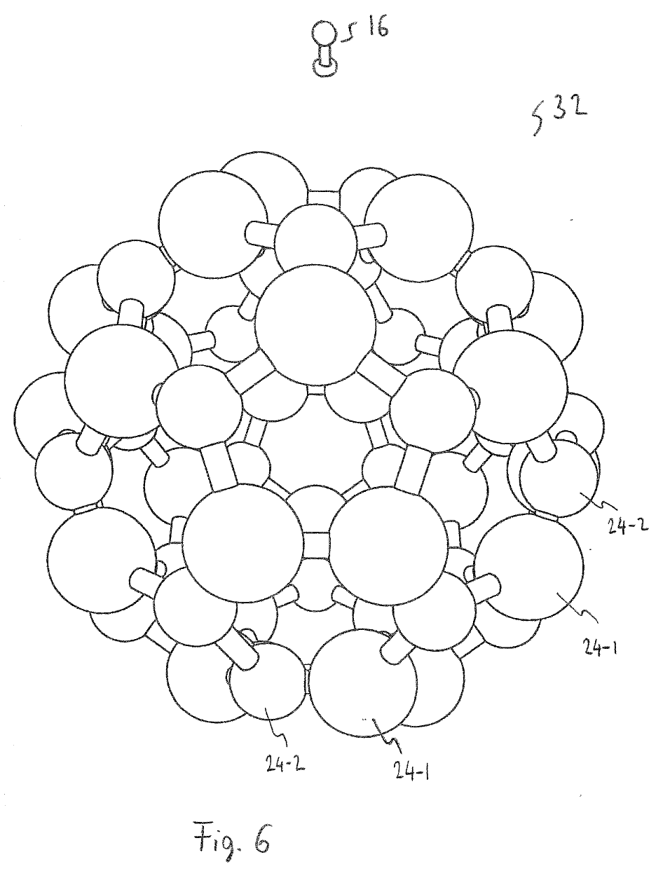

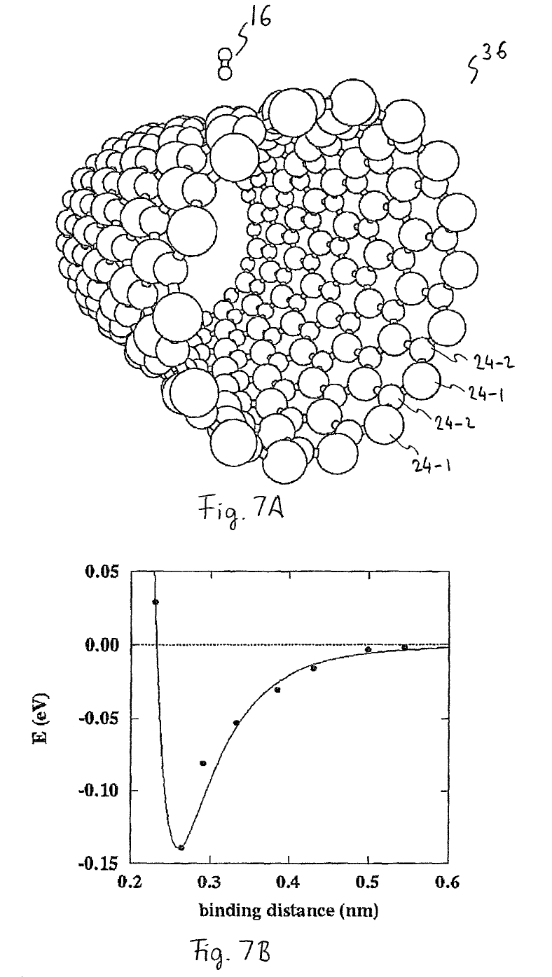

FIG. 7A illustrates some embodiments where the adsorption of hydrogen molecule 16 to nanostructured storage material 22 is enhanced by deforming sp² bonds 8 in a tubular manner. Here nanostructured storage material 22 is deformed into a nanotube 36, formed from two different light elements 24-1 and 24-2, for example, boron and nitrogen. Nanotubes have many advantageous properties, including mechanical and electric conducting advantages. Related embodiments utilize other types of nanotube-related nanostructured storage materials 22. A non-exhaustive list of nanotube-related nanostructured storage materials 22 include:
nanotubes of the following kinds: single walled, double walled, multi walled, with zig-zag chirality, or a mixture of chiralities, twisted, straight, bent, kinked, curled, flattened, and round;
nanofibers of the following kinds: turbostratic, highly oriented, twisted, straight, curled and rigid;
nanorods, and nanowires;
ropes of nanotubes, twisted nanotubes, and braided nanotubes;
small bundles of nanotubes (with a number of tubes less than ten), medium bundles of nanotubes (with a number of tubes in the hundreds), and large bundles of nanotubes (with a number of tubes in the thousands).

FIG. 7B illustrates the dependence of energy on the distance between the surface of nanotube 36 and hydrogen molecule 16. In embodiments with a monoatomic composition, such as carbon, the binding energy E_{B}(C,nanotube) is only marginally bigger than E_{B}(C,planar). In embodiments, where nanotube 36 is formed with a heteroatomic composition, for example, with the binary composition BN, the binding energy E_{B} and desorption temperature T_{D} can be bigger.

In some embodiments the adsorption of hydrogen molecule 16 to nanostructured storage material 22 is enhanced by modifying sp² bonds locally via the introduction of localized defects. The localized defects can modify the hybridization of the s and p electrons locally. The modification of the hybridization of the s and p electrons can change the electronic states. The binding of hydrogen molecules is very sensitive to the character of the electronic states. Therefore the binding energy can be controlled by modifying the sp² bonds by introducing defects into nanostructured storage material 22.

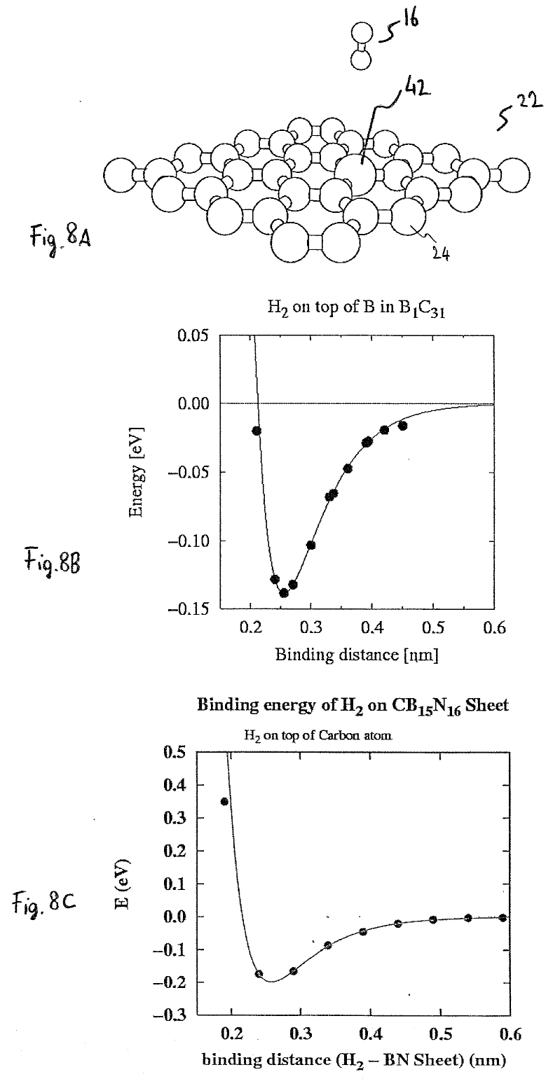

FIG. 8A illustrates some embodiments, where the localized defect is formed by replacing one of the light elements 24 of a layer with a defect atom 42 in nanostructured storage material 22. In the displayed example a boron atom 42 has been included in a layer of carbon atoms 24. Hydrogen molecule 16 has an enhanced binding energy at the location of defect atom 42.

FIG. 8B illustrates the dependence of energy on the distance between the surface of nanostructured storage material 22 and hydrogen molecule 16 near the location of defect atom 42. In the case of the example, the binding energy E_{B}(C,boron defect) is about 0.14 eV, about 40% bigger than E_{B}(C,planar), corresponding to an enhanced value of T_{D} of about 85 K in this embodiment.

Some embodiments include defects formed with atoms other than boron. Some other embodiments include other type of defects, for example, multiatomic defects, where the atoms can be of the same element or different ones, and can be located next to each other or at a few lattice spacing away. All these defect varieties can further enhance the binding energy E_{B} and desorption temperature T_{D}.

FIG. 8C illustrates some embodiment, where nanostructured storage material 22 has a binary chemical composition of light elements 24, for example, boron nitride, BN, and a carbon atom is inserted as defect atom 42. FIG. 8C illustrates the dependence of energy on the distance between the surface of nanostructured storage material 22 and hydrogen molecule 16 near the location of defect atom 42. The binding energy E_{B}(BN, carbon impurity) is about 0.20 eV, about 100% bigger than E_{B}(C,planar), corresponding to an enhanced value of T_{D} of about 120 K in this embodiment.

Defect atoms, or impurities, can be implanted into nanostructured storage materials 22 by several different methods. In some embodiments doping gases are added into the flow of a chemical vapor deposition synthesis. Doping gases include NH₃, CH₃NH₂, (CH₃)₂NH, (CH₃)₃N, BCl₃, BF₃, B₂H₆(or, any other borohydride), SiH₄,Si₂H₆, SiCl₄, SiF₄, SiH₂Cl₂, H₂S, and PH₃.

Some embodiments introduce traces of the element, intended to serve as defect atoms, into a graphite powder. The resulting graphite powder is subsequently hot pressed into the shape of a rod that can be used as an electrode in a classical arc synthesis of nanostructured storage material 22. Most elements of the periodic table can serve as impurities.

Some embodiments introduce the impurities by solid-state chemistry methods, for example, by ball milling nanostructured storage material 22 with a powder of the element, intended to serve as an impurity. In some embodiments nanostructured storage material 22 are ball-milled under a high-pressure atmosphere, containing the element intended to serve as an impurity.

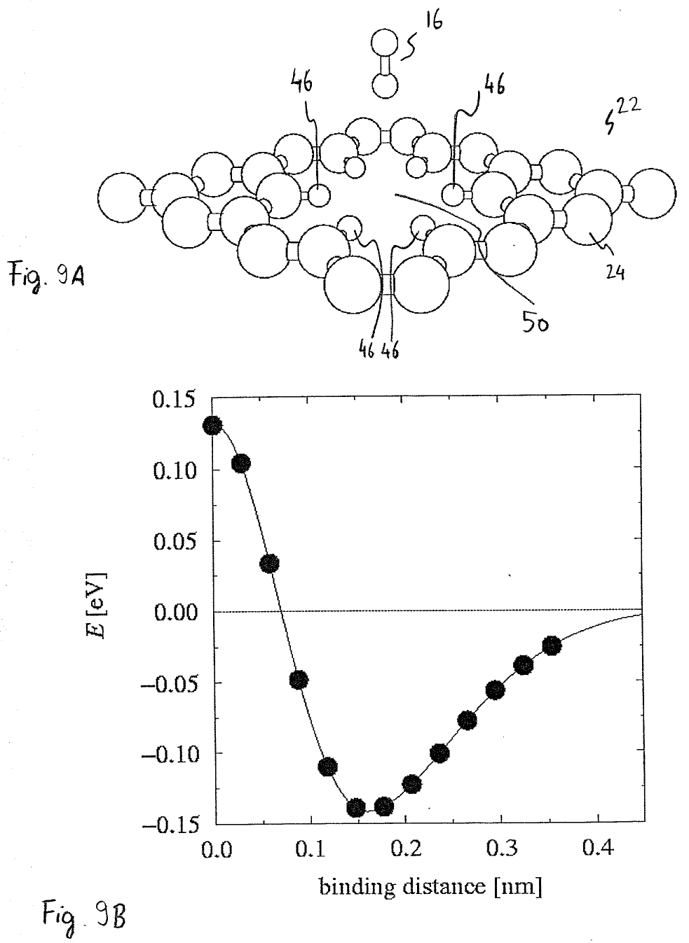

FIG. 9A illustrates some embodiments, where the localized defect is formed by removing one or more atoms of nanostructured storage material 22, for example, the atoms of a hexagon of the triangular lattice. In different embodiments different numbers of atoms can be removed. In some embodiments a different type of atoms can be inserted in the place of the removed atoms. FIG. 9A illustrates an example, where in a layer of carbon atoms 24 six carbon atoms of a hexagon 50 are removed and replaced with six hydrogen atoms 46 to saturate the unpaired dangling bonds of the triangular lattice.

The carbon atoms can be removed by, for example, exposing nanostructured storage material 22 to a flow of ozone, which breaks up some of the hexagons and inserts oxygen into the hexagons. Some hexagons can be completely eliminated by this process. Afterwards, nanostructured storage material 22 can be annealed at a temperature in the range of about 400° C. to about 1800° C. The annealing can take place in vacuum, in a neutral atmosphere, or in an atmosphere containing H₂, for example, an Ar/H₂ mixture. In this atmosphere the oxygen forms CO and CO₂ with the carbon atoms of the nanostructured storage material 22. In some embodiments the carbon atoms are removed in groups, several of them belonging, for example, to the same hexagon. In some embodiments carbon atoms are removed in big enough groups to cause indentations with a size of about 10-100 nanometers, detectable with transmission electron microscopy. The CO and CO₂ leave nanostructured storage material 22 and in some embodiments hydrogen can take the place of some of the carbon atoms.

More generally, removing one or more atoms can be achieved by solution chemistry by partially attacking/etching the materials. For example, in the case of carboneous materials, this can be achieved using strong oxidizing acidic media such as mixtures of H₂SO₄ and HNO₃, or H₂SO₄ and H₂O₂. As another example, in the case of BN, this can be done by partial reaction with F₂, HF, or nitric acid.

In some embodiments the carbon atoms are removed from the nanostructure by irradiation with electrons, neutrons, ions, gamma rays, X-rays, and microwaves. Subsequent exposure to different gaseous atmospheres can again saturate the unsaturated bonds with, for example, hydrogen.

FIG. 9B illustrates the dependence of energy on the distance between the surface of nanostructured storage material 22 and hydrogen molecule 16 near the location of a 6 atom vacancy. The binding energy E_{B}(C,6-atom-vacancy) is about 0.14 eV, about 40% bigger than E_{B}(C,planar), corresponding to an enhanced value of T_{D} of about 85 K in this embodiment.

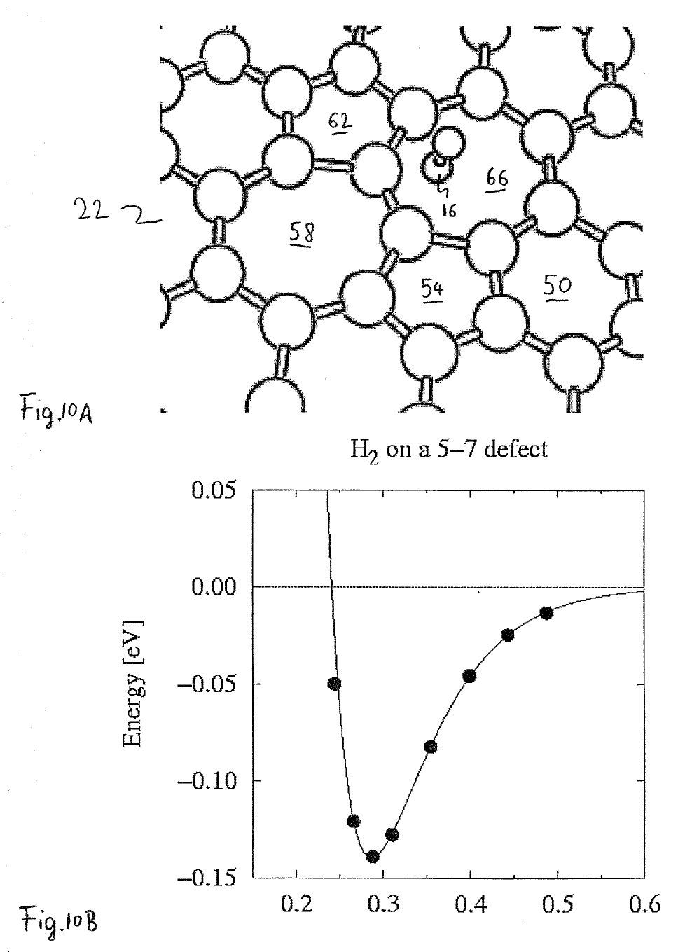

FIG. 10A illustrates some embodiments, where the localized defect is a “5-7” defect. 5-7 defects are a typical defect of triangular lattices. The regular building block of triangular lattices is a hexagon 50, which is a ring of six atoms. A triangular lattice can be formed by covering a plane with hexagons. As shown in FIG. 10A, a hexagon can be deformed into a pentagon defect 54 by eliminating one of the atoms from hexagon 50. Hexagon 50 can also be deformed into a heptagon defect 58 by adding an atom to hexagon 50. The formation of pentagon defect 54 or heptagon defect 58 by itself requires considerable energy, because forming these defects distorts the surrounding lattice extensively. Therefore pentagon and hexagon defects 54, 58 exist in significant concentration only close to the melting temperature of the lattice.

To avoid the high energy of formation, pentagon and heptagon defects 54, 58 often form pairs, known as 5-7 defects, as shown by the pair 54-58 in FIG. 10A. 5-7 pairs cause much less distortion of the surrounding lattice and thus cost less energy to form. However, even the formation of 5-7 defects has a considerable energy cost, so at lower temperatures a 5-7 pair defect will typically pair up with an other 5-7 pair defect, oriented in the opposite direction. In the example of FIG. 10A the second 5-7 pair defect is formed from pentagon 62 and heptagon 66, and has an orientation opposite of the 54-58 pair defect. This 5-7-7-5 configuration can also be generated by rotating a bond of a hexagon ring by 90° in a triangular lattice, sometimes referred to as a Stone-Wales transformation.

FIG. 10B illustrates the dependence of energy on the distance between the surface of nanostructured storage material 22 and hydrogen molecule 16 near the location of a 5-7 defect. The binding energy E_{B}(C,5-7-7-5 defect) is about 0.14 eV, about 40% bigger than E_{B}(C,planar), corresponding to an enhanced value of T_{D} of about 85 K in this embodiment.

Nanostructures containing 5-7 pair defects can be prepared by various methods. Methods using mechanical deformations, for example, stretching, bending and twisting, have been described by B. I. Yakobson et al., in Physical Review Letters, vol. 76, p. 2511 (1996)). Methods utilizing irradiation with electrons, neutrons, gamma rays and X rays have been described by V. H. Crespi et al. in Physical Review Letters, vol. 79, p. 2093 (1997). Additional methods, using mechanical deformations have been described by M. Cohen et al. in U.S. Pat. No. 5,993,697. Both publications and U.S. Pat. No. 5,993,697 are hereby incorporated in their entirety by reference.

Methods using variations of the chemical vapor deposition (CVD) have been described by X. B. Wang, Y. Q. Liu, and D. B. Zhu in Applied Physics A, vol. 71, p. 347 (2000), by X. B. Wang, Y. Q. Liu, and D. B. Zhu in Chemical Communications, No. 8, p. 751 (2001), by P. Nikolaev et al. in Chemical Physics Letters, vol. 313, p. 91 (1999), and by I. W. Chiang et al. in Journal Of Physical Chemistry B, vol. 105, p. 8297 (2001), all four publications hereby incorporated in their entirety by this reference.

In some embodiments, variable amounts of cyclopentadiene, cycloheptatriene, and azulene are introduced, alone or in mixture, in the flow of the CVD process of any one of the referenced methods, in order to nucleate 5-7 pairs, or pentagon and heptagon defects separately. These molecules can be introduced into the flow by boiling a precursor material in a first oven place upstream to the main oven, or by generating an aerosol of the precursor near the entrance of the main oven.

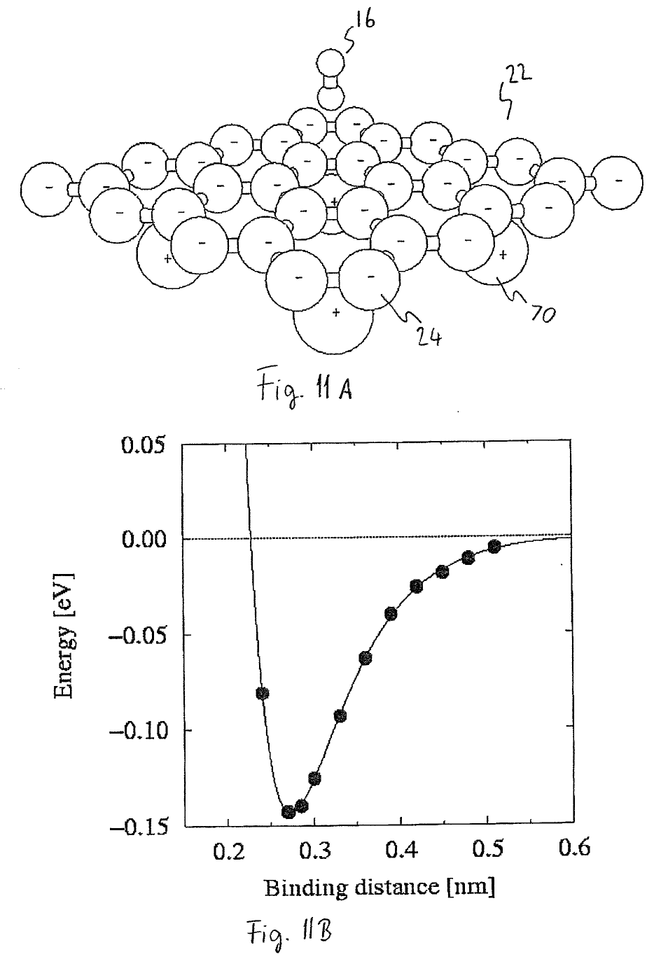

FIG. 11A illustrates some embodiments, where at least some the light elements 24 of nanostructured storage material 22 are charged, as indicated by the “-” signs on the atoms of nanostructured storage material 22. Charging can be achieved by different methods. In some embodiments charges are introduced on nanostructured storage material 22 by forming an doping layer beneath or above nanostructured storage material 22 from dopant atoms 70. In the embodiment shown dopant atoms 70 donate electrons to light elements 24. In other embodiments dopant atoms 70 may accept electrons from light elements 24. Accordingly, the introduced charges can be electrons or holes.

FIG. 11B illustrates the dependence of energy on the distance between the surface of charged nanostructured storage material 22 and hydrogen molecule 16. The binding energy E_{B}(C,charged) is about 0.15 eV, about 50% bigger than E_{B}(C,planar), corresponding to an enhanced value of T_{D} of about 90 K in this embodiment.

In some embodiments sp² bonds 8 can be modified by forming a magnetically ordered nanostructured storage material 22. These magnetic moments can order into an ordered magnetic state, which can also modify sp² bonds 8. Ordered magnetic states include ferromagnetic ordering, antiferromagnetic ordering and ferrimagnetic ordering.

In some embodiments sp² bonds 8 can be modified by exposing nanostructured storage material 22 to a magnetic field.

Some embodiments combine two or more of the above-described embodiments. For example, some embodiments include localized defects, a curvature to nanostructured storage material 22, and 5-7 pairs. Some embodiments include vacancies and a donor layer. Some embodiments include one embodiment in one area of nanostructured storage material 22, and another embodiment in another area of nanostructured storage material 22. For example, during the growth of nanostructured storage material 22, a nanotube may grow in an area of an otherwise flat planar layer. All combinations of the above embodiments are understood to be within the scope of the invention.

Although the various aspects of the present invention have been described with respect to certain embodiments, it is understood that the invention is entitled to protection within the full scope of the appended claims.

1-42. (canceled)

43. A hydrogen storage system, comprising:
a storage material comprising a plurality of non-planar nanostructures formed of at least one light element, wherein the plurality of non-planar nanostructures are selected from the group consisting of nanoplatelets, nanocages, nanococoons, nanotorii, nanotubes, nanofibers, nanorods, nanowires, buckyballs, nanocoils, and nanohoms, the at least one light element is selected from the group consisting of Be, B, C, N, O, F, Mg, P, S, and Cl, and the storage material is characterized by a binding energy to adsorbed hydrogen substantially greater than 0.10 eV; and hydrogen adsorbed by the storage material.

44. The hydrogen storage system of claim 43, wherein the storage material is characterized by a hydrogen desorption temperature greater than about 60 K.

45. The hydrogen storage system of claim 43, wherein the plurality of non-planar nanostructures are selected from the group consisting of thin nanoplatelets, thick nanoplatelets, and intercalated nanoplatelets.

46. The hydrogen storage system of claim 43, wherein the plurality of non-planar nanostructures comprise nanotubes.

47. The hydrogen storage system of claim 43, wherein the plurality of non-planar nanostructures consist essentially of nanotubes.

48. A hydrogen storage system, comprising:
a storage material comprising a plurality of nanostructures formed of a combination of at least two light elements, wherein the plurality of nanostructures are selected from the group consisting of nanoplatelets, nanocages, nanococoons, nanotorii, nanotubes, buckyballs, nanocoils, and nanohoms, the at least two light elements are selected from the group consisting of Be, B, C, N, O, F, Mg, P, S, and Cl, and the plurality of nanostructures each comprise a non-equiangular triangular lattice configured such that the storage material has a binding energy to adsorbed hydrogen substantially greater than 0.10 eV; and
hydrogen adsorbed by the storage material.

49. The hydrogen storage system of claim 48, wherein the storage material is characterized by a hydrogen desorption temperature greater than about 60 K.

50. The hydrogen storage system of claim 48, wherein the at least two light elements consist of a compound of B and N.

51. The hydrogen storage system of claim 48, wherein the at least two light elements consist of a compound of C and N.

52. The hydrogen storage system of claim 48, wherein the at least two light elements consist of a compound of B, C, and N.

53. The hydrogen storage system of claim 48, wherein the at least two light elements consist of a compound of Mg and B.

54. The hydrogen storage system of claim 48, wherein the at least two light elements consist of a compound of B and O.

55. A hydrogen storage system, comprising:
a storage material comprising a plurality of nanostructures formed of at least one light element, wherein the plurality of nanostructures are selected from the group consisting of nanoplatelets, nanocages, nanococoons, nanotorii, nanotubes, buckyballs, nanocoils, and nanohorns, the at least one light element is selected from the group consisting of Be, B, C, N, O, F, Mg, P, S, and Cl, and the plurality of nanostructures are configured with a plurality of lattice defects such that the storage material has a binding energy to adsorbed hydrogen substantially greater than 0.10 eV; and
hydrogen adsorbed by the storage material.

56. The hydrogen storage system of claim 55, wherein the storage material is characterized by a hydrogen desorption temperature greater than about 60 K.

57. The hydrogen storage system of claim 55, wherein the plurality of lattice defects include a substantial number of defects characterized by a light element of a first kind implanted into a molecular lattice formed by a light element of a second kind.

58. The hydrogen storage system of claim 55, wherein the plurality of lattice defects include a substantial number of defects characterized by a light element of a first kind implanted into a molecular lattice formed by light elements of second and third kinds.

59. The hydrogen storage system of claim 55, wherein the plurality of lattice defects include a substantial number of defects characterized by hydrogen atoms coupled to a molecular lattice in place of atoms of the at least one light element that are removed from the lattice.

60. The hydrogen storage system of claim 55, wherein the plurality of lattice defects include a substantial number of defects characterized by a plurality of molecular lattice pentagons coupled to a plurality of molecular lattice heptagons.

61. The hydrogen storage system of claim 60, wherein the plurality of molecular lattice pentagons and the plurality of molecular lattice heptagons are coupled in 5-7 neighbor pairs in the plurality of nanostructures.

62. The hydrogen storage system of claim 55, wherein the plurality of lattice defects include a substantial number of defects characterized by an electron donor atom coupled to a molecular lattice of the plurality of nanostructures.

63. The hydrogen storage system of claim 55, wherein the plurality of lattice defects include a substantial number of defects characterized by an electron acceptor atom coupled to a molecular lattice of the plurality of nanostructures.

64. A method of making a hydrogen storage system, comprising:
forming a storage material comprising a plurality of nanostructures of at least one light element, wherein the plurality of nanostructures are selected from the group consisting of nanoplatelets, nanocages, nanococoons, nanotorii, nanotubes, nanofibers, nanorods, nanowires, buckyballs, nanocoils, and nanohoms, the at least one light element is selected from the group consisting of Be, B, C, N, O, F, Mg, P, S, and Cl, and the storage material is characterized by a binding energy to adsorbed hydrogen substantially greater than 0.10 eV; and
adsorbing hydrogen using the storage material.

65. The method of claim 64, wherein the adsorbing step is performed below a desorption temperature, wherein the desorption temperature is greater than 60 K.

66. The method of claim 64, wherein the forming step further comprises forming the storage material by combining at least two light elements selected from the group consisting of Be, B, C, N, O, F, Mg, P, S, and Cl.

67. The method of claim 64, wherein the forming step further comprises forming the storage material using a chemical vapor deposition synthesis and a flow of doping gas.

68. The method of claim 67, wherein the forming step further comprises forming the storage material using a flow of doping gas, the doping gas selected from the group consisting of NH₃, CH₃NH₂, (CH₃)₂NH, (CH₃)₃N, BCl₃, BF₃, B₂H₆, a borohydride, SiH₄, Si₂H₆, SiCl₄, SiF₄, SiH₂Cl₂, H₂S and PH₃.

69. The method of claim 66, wherein the forming step further comprises forming the storage material by forming a graphite powder and the at least two light elements into an electrode, and then using the electrode to arc synthesize the plurality of nanostructures.

70. The method of claim 64, wherein the forming step further comprises forming the storage material by ball milling the plurality of nanostructures with a powdered dopant.

71. The method of claim 64, wherein the forming step further comprises forming the storage material comprising a plurality of nanostructures having a non-planar shape.

72. The method of claim 64, wherein the forming step further comprises forming the storage material comprising a plurality of nanostructures having a substantial portion of molecular lattice defects.

73. The method of claim 72, wherein the forming step further comprises forming the storage material by exposing the plurality of nanostructures to a flow of ozone, and then annealing the plurality of nanostructures by maintaining a temperature between about 400° C. and about 1800° C.

74. The method of claim 73, wherein the annealing step comprises annealing in one of a vacuum, a neutral atmosphere, and a hydrogen-containing atmosphere.

75. The method of claim 72, wherein the forming step further comprises forming the storage material by removing atoms of the at least one light element from the plurality of nanostructures by a method selected from irradiation with electrons, irradiation with neutrons, irradiation with ions, irradiation with gamma rays, irradiation with X-rays and irradiation with microwaves.

76. The method of claim 72, wherein the forming step further comprises forming the storage material by nucleating 5-7 pair defects in the plurality of nanostructures by introducing at least one of cyclopentandiene, cycloheptatriene and azulene into a flow of a chemical vapor deposition process.

77. The method of claim 72, wherein the forming step further comprises forming the storage material by providing a charge transfer material in proximity to the plurality of nanostructures, and wherein the charge transfer material is selected from an electron donor and an electron acceptor.
